(19) United States
(12) Patent Application Publication
(10) Pub. No.: US 2026/0083099 A1
(43) Pub. Date: Mar. 26, 2026

(54) INTERCHANGEABLE PET COLLAR SYSTEM

(71) Applicant: MiaMilo Limited, Hong Kong (HK)

(72) Inventors: Clas Sivertsen, Lilburn, GA (US); Lester Lau, New Taipei City (TW); Thomas Kuhlenbach, Taipei City (TW)

(73) Assignee: MiaMilo Limited, Hong Kong (HK)

(21) Appl. No.: 18/895,220

(22) Filed: Sep. 24, 2024

(51) Int. Cl. A01K 27/00; B32B 9/02

(52) U.S. Cl. CPC A01K 27/006; A01K 27/001; B32B 9/025; B32B 2250/03

(57) ABSTRACT

An collar system, including a collar having a top layer, a base layer, and a middle layer in between the top layer and the base layer, a charm having a stem extending from the charm, an eyelet coupled to the middle layer of the collar, and at least one spacer coupled between the charm and the collar configured to control a motion of the charm relative to the collar, wherein the charm and the collar are coupled to each other via the stem.

### TECHNICAL FIELD

The present disclosure relates to a collar system, and more particularly to an interchangeable pet collar charm system.

### BACKGROUND

Traditional pet collars may have charms that are fixed, not interchangeable, and not customizable. This means that pet owners cannot easily change the charms on their pet's collar to match their mood or style, and they cannot customize the charms to create a unique look for their pet. Additionally, fixed charms are more likely to be damaged, pulled off, or broken, and they are difficult and expensive to replace without purchasing a new collar.

This can be a problem for pet owners who want to be able to customize their pet's collar and for pet parents who have pets that are active or clumsy. For example, a pet owner may want to put a different charm on their pet's collar for a holiday or special event, or they may want to change the charms to reflect their pet's personality or interests. Additionally, active or clumsy pets may be more likely to damage or lose their collar charms, which can be a significant inconvenience for pet owners.

Based on this, there is a need for an interchangeable pet collar charm system that is easy to use, durable, configurable and aftermarket serviceable, customizable and upgradable. Additionally, there is a need for an interchangeable pet collar charm system that includes an anti-rotation feature to prevent the charms from spinning around for both practical and aesthetic reasons.

### SUMMARY

The present invention discloses an interchangeable pet collar charm system, also referred to as a pet collar personalization system, that allows the user to customize the look of their pet's collar with a variety of interchangeable charms.

In a first aspect of the present disclosure, an interchangeable collar system is provided. The system includes a collar having a top layer, a middle layer, and a base layer; a charm having a threaded stem; an eyelet coupled to the middle layer of the collar; and at least one Anti-Rotation Plate (ARP) coupled to the charm, the ARP including a metal piece with at least one bent corner.

In another aspect of the present disclosure, an interchangeable collar system is provided. The system includes a collar having a top layer, a middle layer, and a base layer; a charm having a threaded stem; an eyelet coupled to the middle layer of the collar; and at least one Rotation Enabling Ring (RER) coupled to the charm, the RER including a ring.

In yet another aspect of the present disclosure, a collar system is provided. The system includes a collar having a top layer, a base layer, and a middle layer in between the top layer and the base layer; a charm having a stem extending from the charm; an eyelet coupled to the middle layer of the collar; and at least one spacer coupled between the charm and the collar configured to control a motion of the charm relative to the collar, wherein the charm and the collar are coupled to each other via the stem.

It should be understood that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

To illustrate the embodiments of the present disclosure or related art more clearly, the following figures that will be described in conjunction with the exemplary embodiments are briefly introduced. The drawings merely reflect some embodiments of the present disclosure, which means that a person of ordinary skill in the field may obtain other figures according to these figures without creative labor. The arrows in the figures indicate a relationship whereby the component the arrow is pointing to is trained/applied using the component the arrow is pointing from. The embodiments of the disclosure will be understood and appreciated more fully from the following detailed description, taken in conjunction with the drawings in which:

FIG. 1A is a cross-sectional view of the interchangeable pet collar charm system according to an embodiment;

FIG. 1B is a cross-sectional view of the interchangeable pet collar charm system according to another embodiment;

FIG. 1C is an isometric view of the interchangeable pet collar charm system, according to an embodiment;

FIG. 1D shows an exploded perspective view of the eyelet within the interchangeable pet collar charm system, according to an embodiment;

FIG. 2 shows a flattened frontal view of the interchangeable pet collar charm system, according to an embodiment;

FIG. 3 shows a front-right perspective view of the interchangeable pet collar charm system, according to an embodiment;

FIG. 4 shows a front-left perspective view of the interchangeable pet collar charm system, according to an embodiment;

FIG. 5 shows a bottom view of the interchangeable pet collar charm system, according to an embodiment;

FIG. 6 shows a closed frontal view of the interchangeable pet collar charm system, according to an embodiment; and

FIG. 7 shows an exploded top view of the interchangeable pet collar charm system, according to an embodiment.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

Embodiments of the disclosure are described in detail with the technical matters, structural features, achieved objects, and effects with reference to the accompanying drawings as follows. Specifically, the terminologies in the embodiments of the present disclosure are merely for the purpose of describing certain embodiments, but not to limit the disclosure. In the following detailed description, numerous specific details are set forth to provide a thorough understanding of the disclosure. However, it will be understood by those skilled in the art that the present disclosure may be practiced without these specific details. In other instances, well-known methods, procedures, and components have not been described in detail so as not to obscure the present disclosure. The subject matter regarding the disclosure is particularly pointed out and distinctly claimed in the concluding portion of the specification. The disclosure, however, both as to organization and method of operation, together with objects, features, and advantages thereof, may best be understood by reference to the following detailed description when read with the accompanying drawings.

The present disclosure proposes an interchangeable pet collar charm system, also referred to as a pet collar personalization system, that allows the user to customize the look of their pet's collar with a variety of interchangeable charm, and discloses at least three exemplary modes of operation for each individual charm, including freely rotating, fixed, and semi-rigid operations.

The interchangeable pet collar charm system is a versatile and customizable system that allows pet owners to create a unique look for their pet's collar. The system is also durable and easy to use, making it a great choice for all pet owners.

The system includes multiple embodiments that involve adding a component: one where each individual charm may freely rotate, and one where the charms are prevented from rotating. This versatility makes the system appealing to a wide range of pet owners, from those who want to change the look of their pet's collar frequently to those who prefer a more classic look.

The present disclosure offers a number of benefits over traditional pet collar charm systems, including:
Ease of use, where the system is easy to use and does not require any special tools or hardware;
Durability, where the charms are very durable and can withstand even the most active pets; and
Customization, where the system allows pet owners to customize their pet's collar with a variety of interchangeable charms.

The benefits may be achieved through the use of the following components, or by having the charm operate in a particular mode:

Rotation Enabling Ring (RER) mode: The optional polymer ring that allows the charm to freely rotate without wear and tear on the leather.

Anti Rotation Plate (ARP) mode: The optional adhesive anti-rotation plate prevents the charms from spinning around.

Semi Rigid (SR) mode: When the ARP and the RER are both omitted, the charm enters a mode where the charm substantially orients in the way that it was installed, and stays in that position without external forces being applied, but will be able to be rotated by the twisting of the charm by use of two or more fingers into a new rotational position.

Overall, the present disclosure provides a superior solution to the problems associated with traditional pet collar charm systems while enabling three different modes of operation for each individual charm, allowing them to be individually configured as freely rotating, fixed, or semi-rigid modes.

The embodiments of the system are distinguished by the way in which the charms are attached to the collar.

In the first embodiment, the charms are allowed to rotate freely. This is achieved by using a simple washer-like ring made from a polymer such as nylon or plastic. The user inserts this ring between the charm and the top layer of the collar, and then slides the stem of the charm through the eyelet. The rotation enabling ring allows the charm to rotate smoothly without damaging the leather.

In the second embodiment, the charms can be configured to be fixed in a predetermined position. This is achieved by using a metal plate made from aluminum or similar metals or alloys. The plate has several corners that are bent up to one side, forming sharp edges that contact, dig into, or bite into the leather of the top layer. The opposite side of the plate is then attached to the charm and adhered through an adhesive. This configuration prevents the charm from rotating relative to the plate, which in turn prevents it from rotating relative to the top layer of the collar. This embodiment is ideal for pet owners who want to create a unique look for their pet's collar or who want to prevent certain charms from rotating.

In the third embodiment, the charms are configured in a semi-rigid position. This is achieved by not having either or ring or metal plate as described in previous paragraphs. the charm enters a mode where the charm substantially orients in the way that it was installed, and stays in that position without external forces being applied, but will be able to be rotated by the twisting of the charm by use of two or more fingers into a new rotational position.

The rotation enabling ring and anti-rotation plate provide additional versatility and functionality, making the system appealing to a wide range of pet owners.

The present disclosure solves the problems previously described by providing a simple, durable, and affordable interchangeable pet collar charm system with an optional adhesive anti-rotation plate. The system is easy to use and does not require any special tools or hardware. The charms are also very durable and can withstand even the most active pets.

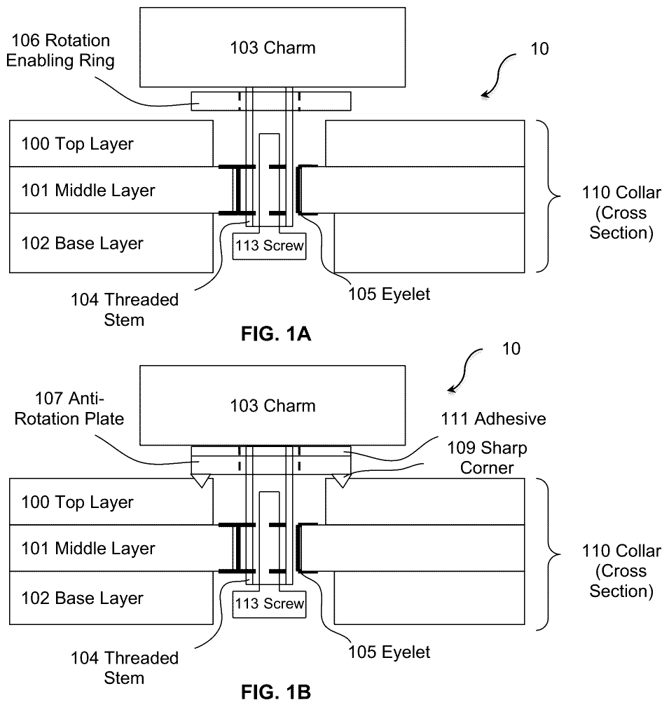

Now referring to FIGS. 1A and 1B, a cross-sectional view of the interchangeable pet collar charm system 10 is shown. The interchangeable pet collar charm system 10 of the present disclosure is a versatile and customizable system that allows pet owners to create a unique look for their pet's collar. The system 10 is also durable and easy to use, making it a great choice for all pet owners.

The system 10 has three main components: a collar 110, a charm 103, and a spacer which may be either a Rotation Enabling Ring (RER) 106 as shown in FIG. 1A or an Anti-Rotation Plate (ARP) 107 as shown in FIG. 1B.

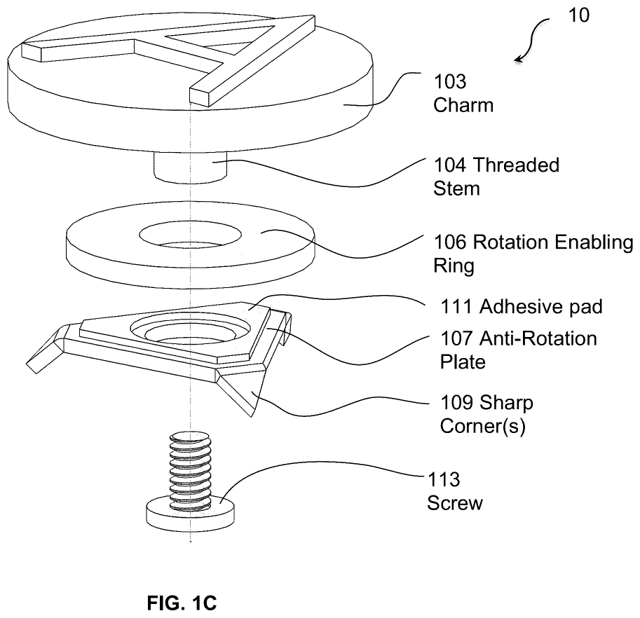

Referring now to FIG. 2, which shows a top view of the interchangeable pet collar charm system 10 that is laid flat in an “open” position. In an embodiment, comparing with FIG. 1A, the collar 110 may be made from durable leather, and has a buckle 201, leash loop 208, punch holes 206, a branding charm 207, charm holes 210, a first stitching 212a, and a second stitching 212b. Here, for clarity purposes in describing the features of the collar 110, the charms are left out.

The buckle 201, which may include a frame 202, prong 203, and bar 204, is used to fasten the collar around the pet's neck by having the opposite end of the collar couple with the buckle 201 through the frame 202 and a loop 205. The opposite end of the collar can then be secured by the prong 203 that fits through one of the punch holes 206. The leash loop 208 is used to attach a leash (not shown) to the collar. In an embodiment, the leash loop may have a length of about 40 mm and a width of 52 mm to fit around the collar, which may have a width of about 42 mm, where the width of the collar meets the leash loop.

The punch holes 206 are used for the prong 203 located on the buckle 201 to fit (i.e., catch) through, so that the end of the collar where the punch holes are located can be fastened to the buckle 201, rendering the collar to be in a “closed” position. In an embodiment, the punch holes may be spaced apart by about 26 mm to allow for variability in adjusting the diameter of the collar in the closed position, so that the collar can fit a variety of different sized pets.

The branding charm 207 may be located at an end of the collar opposite that of the buckle 201, and may have a design distinct from that of the other charms. In an embodiment, the branding charm 207 may be about 45 mm from the nearest punch hole 206.

The charm holes 210 allow for the charm to be coupled to the collar. In an embodiment, the area of the collar where the charms are placed may have a width from about 37 mm-40 mm, to allow for various-sized charms to be coupled to the collar.

The first stitching 212a and the second stitching 212b are meticulously sewn along the entire periphery of the collar 110 to couple the top layer, the middle layer, and bottom layer together securely. Precision and consistency in which the stitching 212a, 212b are sewn along the periphery are crucial, as uneven stitches can compromise the collar's shape and function. Respectively, the first stitching 212a and the second stitching 212b are separately sewn along the buckle end and the opposite end of the collar, and run squared off and parallel against each other as they reach near the leash loop 208 at the center of the collar 110. This design provides more durability in holding the layers together, as damage to on stitching would not affect (i.e., is independent of) the condition of the other stitching. As will be described more in detail below, and as will be made apparent by the additional drawings provided, there are other benefits to this particular sewing pattern of the stitching.

It is noted that the center part of the collar 110 where the charm holes are located are wider that the ends of the collar 110 where the punch holes 206 and the buckle 201 are located on. This allows for more durability for the collar 110 against tears when the collar is yanked by either the pet of its owner. Also, charms with larger diameters can be provided on the collar without having the charms hit each other.

Referring back to FIGS. 1A and 1B, the collar 110 is designed to be comfortable and durable for the pet. The leather that makes up the collar is soft and flexible, but it is also strong enough to withstand the rigors of everyday wear and tear. The buckle in FIG. 2 is easy to use and secure, and the leash loop is strong enough to hold even the most active pets. The collar is also designed to be stylish. It comes in a variety of colors and styles, so pet owners can choose the perfect collar to match their pet's personality.

The collar has three parts: a top layer 100, a middle layer 101, and a base layer 102. The top layer is the most visible portion of the collar and is where the charm is attached. In an embodiment, the top layer 100 may be made from durable leather to withstand the elements and the wear and tear of everyday use.

The middle layer provides support for the charm when it is coupled to the collar through a riveted eyelet 105. In an embodiment, and referring to FIG. 1D, the eyelet may include two pieces, the first piece including a first ring with a flange 115a surrounding a center hole (not shown). The inner part of the first ring with a flange 115a surrounding the center hole protrudes to form a first barrel 117a, which is received by the second piece that also includes a second ring with a flange 115b. The inner part of the second ring with a flange 115b also protrudes to form a second barrel 117b. In an embodiment, the diameter of the second barrel 117b is larger than the diameter of the first barrel 117a so that the second barrel 117b may receive the first barrel 117a of the first piece. Together the first barrel 117a and the second barrel 117b may be coupled to form the center hole within which the threaded stem 104 may pass through to receive the screw 113. However, in another embodiment, the diameter of the first barrel 117a may be larger than that of the second barrel 117b, so long as they may be coupled together.

The eyelet is used to reinforce the holes punched in the middle layer. That is, the first ring with a flange 115a and the second ring with a flange 115b rest on opposite faces of the middle layer 101 so that abrasion and damage to the middle layer are avoided. In an embodiment, the eyelet may be made of metals such as stainless steel or other high-quality metal alloys, and the eyelet is pressed-fitted through the middle layer from the top layer side and formed on the opposite side towards the base layer to create a permanent hole. The eyelet is essential for ensuring that the charm stays securely coupled (i.e., attached) to the collar (e.g., via the threaded stem). That is, in one embodiment, the eyelet may be coupled to the threaded stem extending from the charm.

The base layer is the innermost layer of the collar and is the portion of the product that directly touches the animal. In an embodiment, the base layer may be made from durable leather material that is both comfortable and durable. The base layer is designed to provide long-term frequent use for the animal.

The charm 103 is made from a variety of materials, including metal, plastic, enamel, and even precious metals like gold and silver. The charm may come in a variety of shapes, sizes, and colors, allowing pet owners to create a truly unique look for their pet's collar. In an embodiment, the charms may have a diameter of about 25 mm and fit within the width of the collar where the charms are placed. Also, the charm may be used to express the pet's personality, show off the pet owner's style, or commemorate special occasions. For example, pet owners can choose a charm with their pet's name on them, or a charm that represent their pet's favorite activities. Pet owners can also choose charms to match their own personal style, or to show support for their favorite sports team or charity. The charm is also designed to be durable and easy to clean. They are made from high-quality materials that are resistant to scratches and tarnish. The charm may also be easily removed from the collar for cleaning. Further, multiple charms may be aligned across the length of the collar 110 to allow for customization by the user, between the punch holes 206 and the buckle 201.

The charm 103 may include a threaded stem 104 coupled to and extending from the charm 103, where the threaded stem 104 may be configured to receive a screw 113.

Separately, a spacer such as the RER 106 and ARP 107 is used to couple the charm 103 to the collar 110. The RER is a unique feature of the disclosure that allows charms to rotate freely without damaging the leather. This is a significant improvement over traditional pet collar charm systems, where charms are often fixed in place and can cause the leather to wear and tear. The RER is a simple washer-like ring made from a polymer such as nylon or plastic. It is inserted between the charm and the top layer of the collar, and it allows the charm to rotate smoothly without any friction or resistance. The RER is also very durable and can withstand even the most active pets.

That is, the RER allow the charms to rotate freely without damaging the collar, which may be made of leather. In an embodiment, the RER may be made from a nylon or other type plastic ring that is inserted between the charm and the top layer of the collar.

In contrast, the ARP allows charms to be fixed in a predetermined position. This is ideal for pet owners who want to create a unique look for their pet's collar or who want to prevent certain charms from rotating. In an embodiment, the ARP is a metal plate made from aluminum or similar metals or alloys. It has several corners that are bent up to one side, forming sharp edges that dig into the leather. The opposite side of the plate is then attached to the charm and adhered through an adhesive. This configuration prevents the charm from rotating relative to the plate, which in turn prevents it from rotating relative to the top layer of the collar.

That is, the ARP prevents the charm from rotating, and is made from a metal plate with several corners that are bent up to one side, forming sharp edges that dig into the top layer 100 of the collar. This prevents the charm from rotating relative to the ARP, which in turn prevents the charm from rotating relative to the top layer of the collar.

The RER and ARP are designed to be durable and easy to use. They are also designed to protect the leather of the collar from damage.

The RER is ideal for pet owners who want their pet's charms to rotate freely. This can be helpful for pets who are active and playful, as it allows the charms to move around and not get caught on things. The RER is also ideal for pet owners who want to create a more dynamic look for their pet's collar.

The ARPs are ideal for pet owners who want their pet's charm to stay in place. This can be helpful for pets who are more sedentary, or for pet owners who are concerned about their pet's charm falling off or getting lost. The ARP is also ideal for pet owners who want to create a more classic look for their pet's collar.

Referring now to FIG. 1C, an exploded view of the interchangeable pet collar charm system 10 is shown. For clarity purposes the collar is omitted. The system 10 includes the charm 103 with threaded stem 104, the optional RER 106, optional ARP 107, sharp corners 109, and the screw 113. The ARP has an adhesive layer 111 that, when assembled, touches and adheres to the bottom of the charm 103. It should be understood that while both the RER and the ARP are shown, these are not necessarily to be used at the same time. Instead, here they are shown together for clarity of their relative positioning to the charm.

Operation: Referring back again to FIG. 1A, to attach a charm 103 to the collar 110, the user simply inserts the threaded stem 104 of the charm through the eyelet 105 in the middle layer 101 of the collar. The user then tightens the screw 113 from the back of the collar, securing the charm in place. If the user wants the charm to rotate freely, the user can use an RER 106. To do this, the user may simply insert the RER between the charm and the top layer 100 of the collar before tightening the screw. The RER will allow the charm to rotate smoothly without damaging the top layer of the collar.

In the alternative, and referring to FIG. 1B, if the user wants to prevent the charm from rotating, the user can use an ARP 107. To do this, the user may simply peel off the adhesive backing 111 from the ARP and adhere it to the bottom of the charm. The ARP will prevent the charm from rotating relative to the plate, which in turn prevents the ARP from rotating relative to the top layer of the collar.

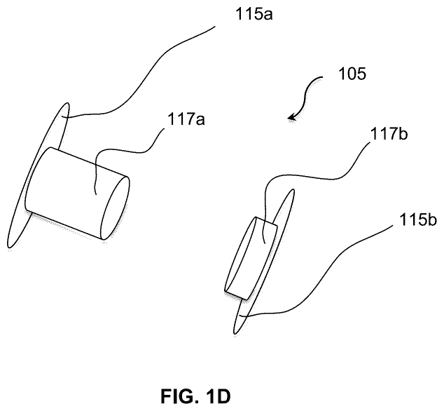

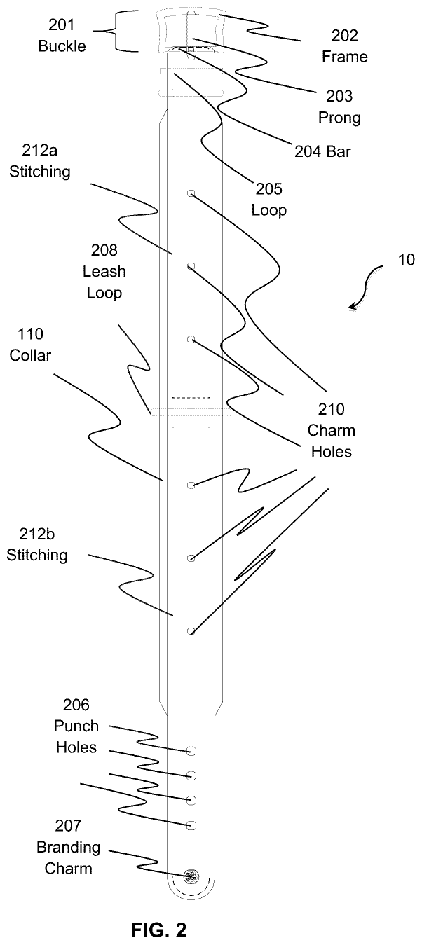

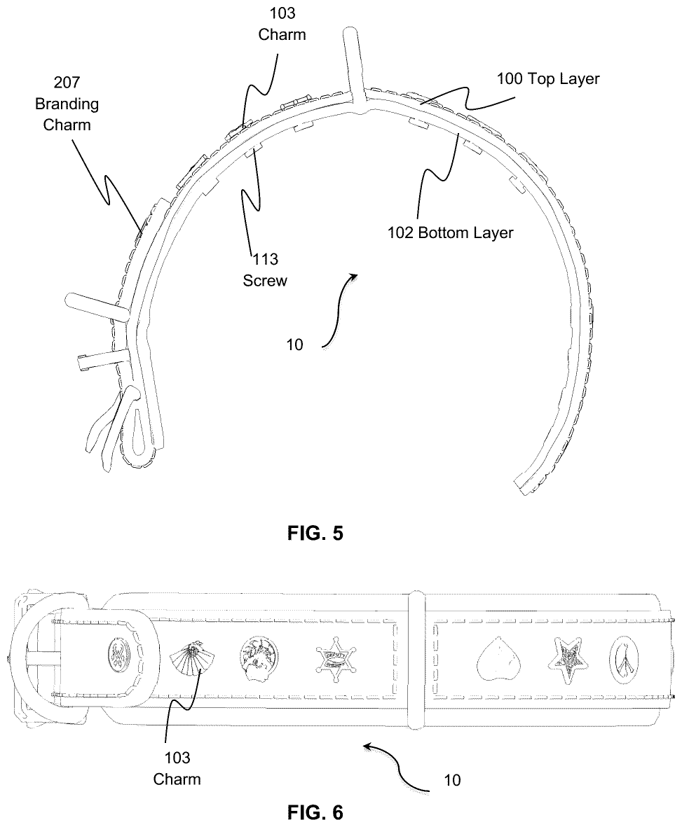

Referring to FIGS. 3, 4, and 6, various perspective views and a frontal view of the system 10 is shown with charms coupled to the collar. Here, charms of various sizes and shapes (e.g., seashell, starred, heart, peace-sign, etc.) may couple to the collar.

Also, in an embodiment a wider region at the center of the collar is formed as part of the bottom layer 102, while the narrower top layer 100 is formed to lay over the bottom layer. At the same time, the first stitching 212a and the second stitching 212b secure the top and bottom layers together. The squaring off of the first stitching 212a and the second stitching 21b at the center section of the collar, besides the benefits discussed above with regards to FIG. 2, also allows for the leash loop 208 to fit securely at the center of the collar 110 in the space between the first stitching 212a and the second stitching 212b, while at the same time allow for the leash loop to move freely as the pet moves around while being held by a leash (not shown).

Further, in an embodiment, and referring specifically to FIG. 3, the branding charm 207 may be coupled to the end of the collar 110 where the buckle and loop are located. Here, and as will be described further below, the branding charm has a functional use holding the buckle and the loop together without the need of glue or additional stitching. This provides for simplicity while adding durability of the collar.

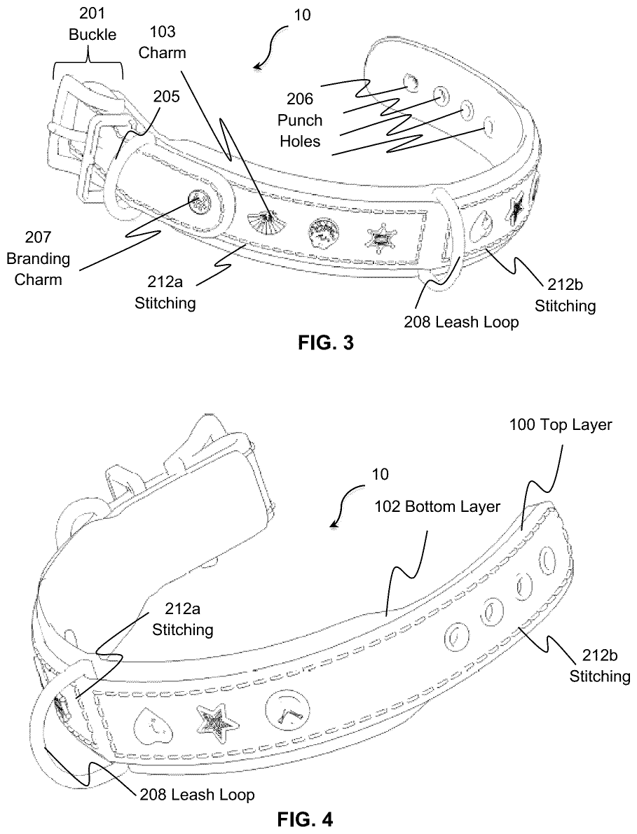

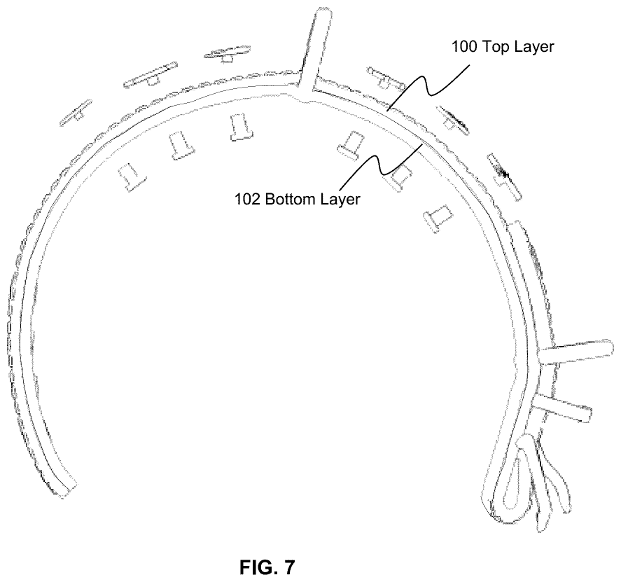

Referring to FIGS. 5 and 7 a bottom and a top view of the system 10 are respectively shown, with FIG. 5 showing the charm 103 being coupled to the collar with the screw 113, while FIG. 7 shows the exploded view of the charms and the screws surrounding the collar. Similar to as described with regard to FIG. 3, the bottom layer is coupled with the top layer. Also, the top layer wraps around itself by the end where the buckle is located, and may be secured with the other layers by either/or the stitching or the branding charm 207 to hold the buckle 201, the bar 204, and the loop 205 in place. As noted in previous examples embodied by FIGS. 3, 4, and 6 above, interlaying of the top layer and bottom layer also secures the leash lop 208. Overall, the structure of the system 10 allows for a simple, durable design in which the user may easily and interchangeably change the charms from the collar, while strengthening the system 10 as a whole.

Advantages: The interchangeable pet collar charm system of the present disclosure has several advantages over traditional pet collar charm systems.

First, the system is more versatile. Pet owners can choose to have their pet's charms rotate freely or stay in place, depending on their desired look. This versatility is not available with traditional pet collar charm systems, where the charms are typically either fixed in place or free to rotate randomly. Also, the system can be used with a variety of different charms.

Second, the system is more durable. The RERs and ARPs are designed to protect the high-quality materials such as leather of the collar from damage, even with frequent use by even the most active pets. This is important because traditional pet collar charm systems can often cause the leather to wear and tear.

Third, the system is easier to use. The charms are easy to attach and remove, and does not require any special tools or hardware other than a simple screwdriver, and the RERs and ARPs are easy to use. This makes it easy for pet owners to change their pet's look without having to buy a new collar.

Fourth, the system is highly customizable and allows pet owners to create a unique look for their pet's collar by coupling a variety of charms to the collar, each of the charms having an adjustable range of motion through the use of RER or ARP, or by not using them at all.

Applications: The interchangeable pet collar charm system of the present disclosure has a variety of applications. It can be used to: Express the pet's personality, show off the pet owner's style, commemorate special occasions, Support charities or sports teams, or identify the pet in case it gets lost.

The system is also ideal for businesses that sell pet-related products. Businesses can use the system to create their own unique line of pet collar charms, or they can offer the system to their customers as a way to customize their pet collars.

The interchangeable pet collar charm system of the present disclosure is a versatile, durable, and easy-to-use system that allows pet owners to create a unique look for their pet's collar. The system has a variety of applications and is ideal for both pet owners and businesses that sell pet-related products.

Other modifications, variations and alternatives are also possible. The specifications and drawings are, accordingly, to be regarded in an illustrative rather than in a restrictive sense. In the claims, any reference signs placed between parentheses shall not be construed as limiting the claim. The word ‘comprising’ does not exclude the presence of other elements or steps than those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage. While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination. It will be appreciated by people skilled in the art that the embodiments of the disclosure are not limited by what has been particularly shown and described hereinabove. Rather the scope of the embodiments of the disclosure is defined by the appended claims and equivalents thereof.

The previous description of the disclosed embodiments is provided to enable others to make or use the disclosed subject matter. Various modifications to these embodiments will be readily apparent, and the generic principles defined herein may be applied to other embodiments without departing from the spirit or scope of the previous description. Thus, the previous description is not intended to be limited to the embodiments shown herein but is to be accorded the widest scope consistent with the principles and novel features disclosed herein. Thus, the claims are not intended to be limited to the aspects shown herein but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout the previous description that are known or later come to be known are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.” It is understood that the specific order or hierarchy of blocks in the processes disclosed is an example of illustrative approaches. Based upon design preferences, it is understood that the specific order or hierarchy of blocks in the processes may be rearranged while remaining within the scope of the previous description. The accompanying method claims present elements of the various blocks in a sample order and are not meant to be limited to the specific order or hierarchy presented.

The various examples illustrated and described are provided merely as examples to illustrate various features of the claims. However, features shown and described with respect to any given example are not necessarily limited to the associated example and may be used or combined with other examples that are shown and described. Further, the claims are not intended to be limited by any one example. The foregoing method descriptions and the process flow diagrams are provided merely as illustrative examples and are not intended to require or imply that the blocks of various examples must be performed in the order presented. As will be appreciated, the order of blocks in the foregoing examples may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

Further Embodiments are listed below.

Embodiment 1. An interchangeable collar system, including a collar having a top layer, a middle layer, and a base layer; a charm having a threaded stem; an eyelet coupled to the middle layer of the collar; and at least one Anti-Rotation Plate (ARP) coupled to the charm, the ARP comprising a metal piece with at least one bent corner.

Embodiment 2. The system of Embodiment 1, wherein the metal piece is stamped and formed out of a metal sheet, and the at least one corner is bent at the time of stamping.

Embodiment 3. The system of any of Embodiments 1-2, wherein the ARP is made from a durable metal including stainless steel or brass.

Embodiment 4. The system of any of Embodiments 1-3, wherein the ARP is coupled to surround the threaded stem.

Embodiment 5. The system of any of Embodiments 1-4, wherein the ARP is configured to be concentrically mounted around the threaded stem.

Embodiment 6. The system of any of Embodiments 1-5, further including an adhesive layer that is configured to couple the ARP with the charm.

Embodiment 7. The system of any of Embodiments 1-6, further including a screw, wherein the at least one bent corner is configured to couple with the top layer to prevent the charm from rotating when the screw is fully tightened.

Embodiment 8. The system of any of Embodiments 1-7, further including a screw located at a side of the collar opposite the charm.

Embodiment 9. The system of any of Embodiments 1-8, wherein the threaded stem is configured to receive the screw.

Embodiment 10. The system of any of Embodiments 1-9, wherein the eyelet is configured to ensure that the charm is coupled to the collar.

Embodiment 11. The system of any of Embodiments 1-10, wherein the middle layer is located between the top layer and the base layer.

Embodiment 12. An interchangeable collar system, including a collar having a top layer, a middle layer, and a base layer; a charm having a threaded stem; an eyelet coupled to the middle layer of the collar; and at least one Rotation Enabling Ring (RER) coupled to the charm, the RER comprising a ring.

Embodiment 13. The system of Embodiment 12, wherein the RER is located between the top layer of the collar and the charm, and configured to allow the charm to rotate freely relative to the collar.

Embodiment 14. The system of any of Embodiments 12-13, wherein the RER is made of nylon.

Embodiment 15. The system of any of Embodiments 12-14, wherein the RER is coupled to surround the threaded stem.

Embodiment 16. The system of any of Embodiments 12-15, wherein the RER is configured to be concentrically mounted around the threaded stem.

Embodiment 17. The system of any of Embodiments 12-16, further including a screw.

Embodiment 18. The system of any of Embodiments 12-17, wherein the screw is located at a side of the collar opposite the charm.

Embodiment 19. The system of any of Embodiments 12-18, wherein the threaded stem is configured to receive the screw.

Embodiment 20. An collar system, including a collar having a top layer, a base layer, and a middle layer in between the top layer and the base layer; a charm having a stem extending from the charm; an eyelet coupled to the middle layer of the collar; and at least one spacer coupled between the charm and the collar configured to control a motion of the charm relative to the collar, wherein the charm and the collar are coupled to each other via the stem.

What is claimed is:

1. An interchangeable collar system, comprising:
a collar having a top layer, a middle layer, and a base layer;
a charm having a threaded stem;
an eyelet coupled to the middle layer of the collar; and
at least one Anti-Rotation Plate (ARP) coupled to the charm, the ARP comprising a metal piece with at least one bent corner.

2. The system of claim 1, wherein the metal piece is stamped and formed out of a metal sheet, and the at least one corner is bent at the time of stamping.

3. The system of claim 1, wherein the ARP is made from a durable metal including stainless steel or brass.

4. The system of claim 1, wherein the ARP is coupled to surround the threaded stem.

5. The system of claim 1, wherein the ARP is configured to be concentrically mounted around the threaded stem.

6. The system of claim 1, further comprising an adhesive layer that is configured to couple the ARP with the charm.

7. The system of claim 1, further comprising a screw, wherein the at least one bent corner is configured to couple with the top layer to prevent the charm from rotating when the screw is fully tightened.

8. The system of claim 1, further comprising a screw located at a side of the collar opposite the charm.

9. The system of claim 8, wherein the threaded stem is configured to receive the screw.

10. The system of claim 1, wherein the eyelet is configured to ensure that the charm is coupled to the collar.

11. The system of claim 1, wherein the middle layer is located between the top layer and the base layer.

12. An interchangeable collar system, comprising:
a collar having a top layer, a middle layer, and a base layer;
a charm having a threaded stem;
an eyelet coupled to the middle layer of the collar; and
at least one Rotation Enabling Ring (RER) coupled to the charm, the RER comprising a ring.

13. The system of claim 12, wherein the RER is located between the top layer of the collar and the charm, and configured to allow the charm to rotate freely relative to the collar.

14. The system of claim 12, wherein the RER is made of nylon.

15. The system of claim 12, wherein the RER is coupled to surround the threaded stem.

16. The system of claim 12, wherein the RER is configured to be concentrically mounted around the threaded stem.

17. The system of claim 12, further comprising a screw.

18. The system of claim 16, wherein the screw is located at a side of the collar opposite the charm.

19. The system of claim 17 wherein the threaded stem is configured to receive the screw.

20. An collar system, comprising:
a collar having a top layer, a base layer, and a middle layer in between the top layer and the base layer;
a charm having a stem extending from the charm;
an eyelet coupled to the middle layer of the collar; and
at least one spacer coupled between the charm and the collar configured to control a motion of the charm relative to the collar,
wherein the charm and the collar are coupled to each other via the stem.
